(19) United States
(12) Patent Application Publication
(10) Pub. No.: US 2025/0044782 A1
(43) Pub. Date: Feb. 6, 2025

(54) HYDRAULIC ANALYSIS PLATFORM

(71) Applicant: Utilimatics, LLC, Austin, TX (US)

(72) Inventors: Andrew Boyle, San Jose, CA (US); Christopher Kite, Spicewood, TX (US)

(73) Assignee: Utilimatics, LLC, Austin, TX (US)

(21) Appl. No.: 18/364,844

(22) Filed: Aug. 3, 2023

(51) Int. Cl. G05B 23/02

(52) U.S. Cl. CPC G05B 23/0275

(57) ABSTRACT

Systems and methods directed to managing a hydraulic distribution network of a water utility are described herein. In examples, a data model is configured to receive data from a plurality of hydraulic sensors located at a boundary zone of the water utility. In some examples a water mass balancer determines the presence of an anomalous event based on a metered amount of water flowing into the zone of the water utility and a metered amount of water flowing out of the zone of the water utility. To identify a location of the anomalous event, a hydraulic model performs a plurality of simulations at multiple locations of the zone of the water utility by generating simulated data for one or more hydraulic sensors within the zone of the water utility based on the data received from the plurality of hydraulic sensors located at the boundary zone of the water utility.

### BACKGROUND

Water scarcity, inefficient water usage, and inadequate monitoring of water systems have become significant challenges in modern societies. The increasing global population, urbanization, and industrial growth have placed immense pressure on water resources, necessitating the implementation of smart and reliable water management solutions. Conventional water utility systems often suffer from shortcomings such as water leakage, inaccurate billing, lack of real-time monitoring, and inefficient distribution. Existing water utility systems generally rely on traditional metering devices and manual monitoring, leading to limited data accuracy and delayed detection of leakages or abnormalities. Some recent developments have incorporated automated meter reading (AMR) and advanced metering infrastructure (AMI) technologies. While these systems have improved data collection, they are often costly to implement, lacking in robustness, and fail to offer comprehensive monitoring and optimization features.

It is with respect to these and other general considerations that examples have been described. Although relatively specific problems have been discussed, the examples described herein should not be limited to solving the problems identified in the background above.

### SUMMARY

In view of the preceding background, it is, therefore, an object of the present disclosure to provide a hydraulic analysis platform that integrates disparate operational and asset management utility datasets into a single interface to manage a hydraulic distribution network of a water utility for example. Such datasets can include but are not limited to Geographic Information Systems (GIS), Supervisory Control and Data Acquisition (SCADA), Advanced Metering Infrastructure (AMI), and one or more hydraulic models, where a hydraulic model may be specific to a geographic location or may be a general hydraulic and/or data model utilizing standardized input and output data. The hydraulic analysis platform can receive sensor readings from one or more data providers, where the sensor readings may refer to water flow and water pressure measured at various locations throughout a zone of a water utility. In some examples, the data providers can include public or private data providers. For example, a water utility may be divided into one or more zones or districts, where each zone or district can include primary water meters capable of measuring water flowing into the zone or district and water leaving the zone or district. In some examples, other public and/or private sensors within the zone or district can be utilized by the hydraulic analysis platform, where the hydraulic analysis platform can receive the sensor information. In accordance with examples of the present disclosure, the hydraulic analysis platform can ingest from one or more data providers, receive sensor information directly from one or more sensors, and/or combinations thereof, where such data can be provided in real-time, at timed intervals, or in accordance with a scheduled event.

In examples, the hydraulic analysis platform can utilize each of the aforementioned datasets to provide a streaming interface that allows a user to view conditions in a zone district for a specified time period for which sensor data is acquired, analyzed, and/or recorded. In some examples, the hydraulic analysis platform can include a data model, which catalogs and analyzes data from one or more sensors, and a hydraulic model, which models the physical interactions of the water flowing through the zone or district. The inputs and outputs of the data model and the hydraulic model can overlap considerably. For example, the hydraulic analysis platform can utilize sensor data to complete a water mass balance at a boundary of the zone or district, such as at pressure zones and/or at district metered areas. The water mass balance is the sum of all water flow entering the zone or district less water flow leaving the zone or district and water flow entering and/or exiting storage vessels. The hydraulic analysis platform can utilize AMI meters at metered connections and pressure sensors (either connected to SCADA or a separate monitoring database) at points of entry into the zone or district as well as at other points throughout the zone or district. In some examples, the hydraulic analysis platform, via the data model, can complete a mass balance at periodic timesteps to determine whether the volume of water leaving the zone or system through metered connections is equal to the volume of water entering the zone or system at the boundaries or being stored. If the data model identifies an anomalous discrepancy, the rate of non-revenue water (NRW—water leaving the zone or district without being metered, typically due to leaks or flushing) is totaled and the hydraulic analysis platform can perform a simulation with the identified rate of NRW applied at various points throughout the zone or system, for example at water mains, branches, storage vessels, or otherwise. In examples, higher flow rates of water throughout a zone or district correlate with lower observed pressures. Thus, since the conditions that the hydraulic model uses to analyze the zone or district are based on metered flows, the calibrated hydraulic model can determine or calculate a higher pressure at remotely monitored pressure points throughout the zone or system. The hydraulic analysis platform can then compare observed pressures during the identified leak event with the simulated pressure in each of the independent simulations in which the NRW rate is applied throughout the zone or system. The simulated locations of the NRW which align most closely with the observed remote system pressures can be categorized, identified, and/or recorded and communicated to utility staff as the most likely locations of a new leak. Existing leaks in the system can be accounted for when the system comes online; for example, the hydraulic analysis platform can use optimization and uncertainty analyses (such as Monte Carlo simulations) to analyze several potential leak locations.

In some examples, the hydraulic analysis platform can utilize pressure recorder equipment with impulse monitoring capabilities, where available. The impulse recording equipment can read system pressures at a much more frequent sampling rate than SCADA or standard pressure recorders. This sampling method allows the recorders to detect potentially damaging surge events. The hydraulic analysis platform can then flag these events and leverage the spatial components of GIS information as well as one or more hydraulic models to alert users of potential leaks or other issues, such as potential damage to one or more components of the zone or district. In some examples, hydraulic analysis platform can utilize Laboratory Information Management Systems (LIMS) to flag anomalous samples and automatically trigger hydraulic modeling source trace simulations to determine the potential extent of the contamination event. In some examples, the hydraulic analysis platform can be incorporated with Computerized Management Maintenance Systems (CMMS) to determine short and intermediate-term impacts to planned maintenance activities (e.g., the resilience of a system to a fire with the planned removal from service of a pump).

In accordance with examples of the present disclosure, a hydraulic analysis platform for managing a hydraulic distribution network of a water utility is described. In examples, the hydraulic analysis platform includes a data model configured to receive data from a plurality of hydraulic sensors, where the plurality of hydraulic sensors is located at a boundary zone of the water utility and include at least one pressure sensor and at least one flow meter. In some examples, a water mass balancer is configured to determine the presence of an anomalous event based on a metered amount of water flowing into the zone of the water utility and a metered amount of water flowing out of the zone of the water utility. Further, a hydraulic model can perform a plurality of simulations at multiple locations of the zone of the water utility when the water mass balancer determines an anomalous event is present, where for each location of the multiple locations, the hydraulic model generates simulated data for one or more hydraulic sensors within the zone of the water utility based on the data received from the plurality of hydraulic sensors located at the boundary zone of the water utility and a difference between the metered amount of water flowing into the zone of the water utility and the metered amount of water flowing out of the zone of the water utility. In some examples, a location of the anomalous event is identified based on simulated data for the one or more hydraulic sensors being closest to the data received from the plurality of hydraulic sensors located at the boundary zone of the water utility. In some examples, the hydraulic analysis platform can generate an anomalous event notification based on the location of the anomalous event and the difference between the metered amount of water flowing into the zone of the water utility and the metered amount of water flowing out of the zone of the water utility.

In accordance with examples of the present disclosure, a method for managing a hydraulic distribution network of a water utility is described. In examples, the method includes receiving data from a plurality of hydraulic sensors located at a boundary zone of the water utility, the plurality of hydraulic sensors including at least one pressure sensor and at least one flow meter. The method may include determining the presence of an anomalous event based on a metered amount of water flowing into the zone of the water utility and a metered amount of water flowing out of the zone of the water utility. The method may further include performing a plurality of simulations at multiple locations of the zone of the water utility when the anomalous event is present by generating simulated data for one or more hydraulic sensors within the zone of the water utility based on the data received from the plurality of hydraulic sensors located at the boundary zone of the water utility and a difference between the metered amount of water flowing into the zone of the water utility and the metered amount of water flowing out of the zone of the water utility. In some examples, the method may include identifying a location of the anomalous event based on the simulated data for the one or more hydraulic sensors being closest to the data received from the plurality of hydraulic sensors located at the boundary zone of the water utility.

In accordance with examples of the present disclosure, a system for managing a hydraulic distribution network of a water utility is described. The hydraulic analysis platform can include a data model configured to receive data from a plurality of hydraulic sensors, wherein the plurality of hydraulic sensors is located at a boundary zone of the water utility and include at least one pressure sensor and at least one flow meter, a water mass balancer configured to determine a presence of an anomalous event based on a metered amount of water flowing into the zone of the water utility and a metered amount of water flowing out of the zone of the water utility, and a hydraulic model configured to perform a plurality of simulations at multiple locations of the zone of the water utility when the water mass balancer determines an anomalous event is present, wherein for each location of the multiple locations, the hydraulic model generates simulated data for one or more hydraulic sensors within the zone of the water utility based on the data received from the plurality of hydraulic sensors located at the boundary zone of the water utility and a difference between the metered amount of water flowing into the zone of the water utility and the metered amount of water flowing out of the zone of the water utility, wherein a location of the anomalous event is identified based on simulated data for the one or more hydraulic sensors being closest to the data received from the plurality of hydraulic sensors located at the boundary zone of the water utility. In some examples, the hydraulic analysis platform is configured to generate one or more signals to control one or more valves of the zone of the water utility based on the location of the anomalous event. In some examples, the anomalous event can be a water leak.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 depicts additional details of a hydraulic analysis platform in accordance with examples of the present disclosure.

FIG. 2 depicts additional details of a hydraulic analysis platform in accordance with examples of the present disclosure.

FIG. 3A depicts additional details of a data structure created to store sensor data and/or GIS data or other data processed by the data model of FIG. 2.

FIG. 3B depicts additional details of example hydraulic models in accordance with examples of the present disclosure.

FIG. 4 depicts details of methods for identifying deviations existing between simulated results and actual sensor readings in accordance with examples of the present disclosure.

FIG. 5 depicts details of methods for identifying leak locations in a district or zone of a water utility in accordance with examples of the present disclosure.

FIG. 6 depicts details of methods for calibrating a hydraulic analysis platform specific to a zone or district of a water utility in accordance with examples of the present disclosure.

FIG. 7 depicts details of method for selecting a hydraulic model and performing a hydraulic simulation using the selected hydraulic model in accordance with examples of the present disclosure.

FIG. 8 is a block diagram illustrating physical components (e.g., hardware) of a computing system, such as a hydraulic analysis platform, with which aspects of the disclosure may be practiced.

FIG. 9 depicts additional details of a system for processing data in accordance with examples of the present disclosure.

### DETAILED DESCRIPTION

In the following detailed description, references are made to the accompanying drawings that form a part hereof and which are shown by way of an illustrations specific examples. These aspects may be combined, other aspects may be utilized, and structural changes may be made without departing from the present disclosure. Examples may be practiced as methods, systems, and/or in accordance with swing training apparatus structures. The following detailed description is therefore not to be taken in a limiting sense, and the scope of the present disclosure is defined by the appended claims and their equivalents.

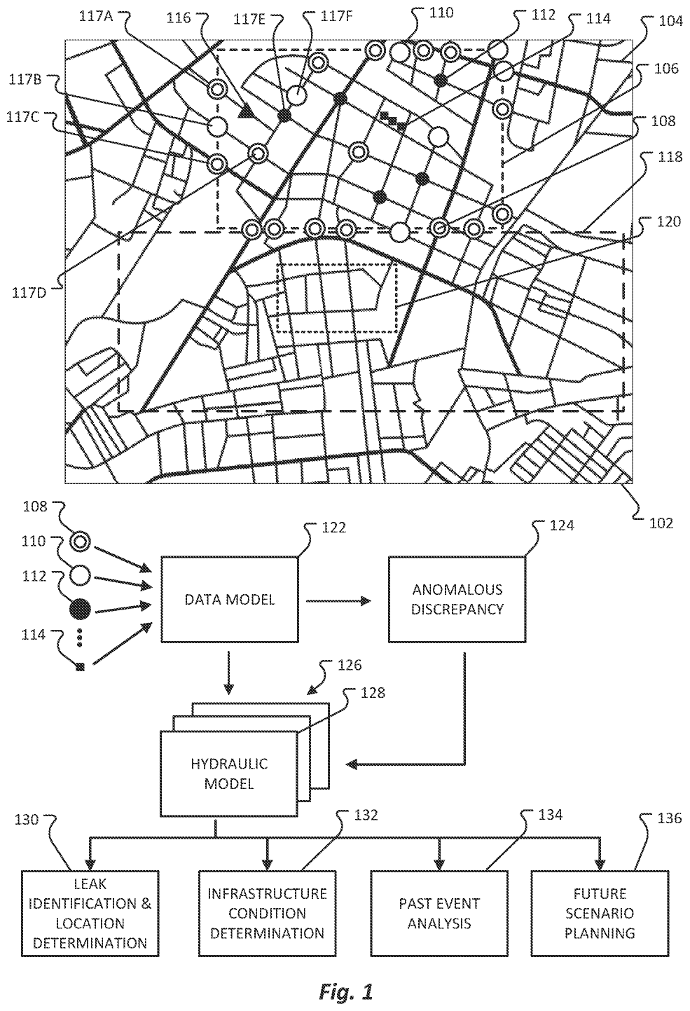

FIG. 1 depicts additional details of a hydraulic analysis platform in accordance with examples of the present disclosure. The hydraulic analysis platform can provide a user interface or otherwise depict one or more zones or districts of one or more water utilities as depicted by reference character 102. For example, a depiction 102 may include a plurality of water lines 104, where each water line 104 may correspond to one or more aspects of a water utility infrastructure. For example, the water lines 104 may be different sizes, made of different materials, run in different directions, and may be connected to or coupled to one another thereby creating a water utility infrastructure. As further depicted in FIG. 1, a first district or zone 106 is illustrated, where the district or zone 106 can include a plurality of water lines 104 and a plurality of sensors. That is, a first sensor 108 can include a sensor capable of measuring or otherwise obtaining pressure and/or flow readings for one or more water lines 104. As another example, a sensor 110 may be a sensor capable of reading or otherwise obtaining a pressure reading of one or more water lines. In some examples, other sensors 112 and 114 may be capable of reading pressure and/or flow at different intervals as well as the other sensors 112 and/or 114 may reside within the district or zone 106. In some examples, the sensors 108 and 110 may be located at a boundary of the district or zone 106. That is, water flowing into district or zone 106 can be measured and water flowing out of the district or zone 106 can be measured. In some examples, one or more other sensors 112 and 114 can measure a stored amount of water, for example, in a water tower, water facility, containers, vessels, or otherwise. Thus, for example, when a mass water balance is performed on district or zone 106, the water flowing in can match the water flowing out, while considering the water being stored in one or more storage vessels. In some examples, the mass water balance can consider previously identified leaks and/or previously identified water flowing out of the district or zone 106 at one or more connections within the district or zone 106. For example, AMI data for connections within district or zone 106 can be used when performing the mass water balance.

As further depicted in FIG. 1, other zones or districts 118 can be displayed to a user or otherwise considered by the hydraulic analysis platform. That is, the zone or district 118 can refer to another zone or district 118 and in some instances can be adjacent to the zone or district 106. In accordance with some examples, a zone or district can include a subzone or district, such as the subzone or district 120 within the zone or district 118. Thus, water flow and pressure readings can be obtained or otherwise localized to a portion of the district or zone 120.

In accordance with some examples of the present disclosure, pressure, and flow readings from pressure and/or flow sensor 108, pressure sensor 110, and other sensors 112 and 114 can be provided to the data model 122. As previously discussed, the data model 122 can receive these sensor readings, process the sensor readings, and store the sensor readings as sensor data. In some examples, the data model can further predict or otherwise determine other sensor readings for other portions of a district or zone. For example, where a pressure and/or flow reading is obtained at a first end of a water line, and a pressure or flow reading is obtained for a second end or portion of the water line, the data model can predict a pressure and/or flow within the specific water line at locations between the first end and the second end. In accordance with some examples of the present disclosure, the data model 122 can utilize one or more sub models to predict water demand. As one example, the water demand can be predicted using one or more machine learning models and/or an Auto-Regressive Integrated Moving Average (ARIMA) model.

In accordance with some examples of the present disclosure, and as previously discussed, a water mass balance process can be performed for one or more districts or zones. For example, water flowing into a zone or district may deviate from the water flowing out of the zone or district by a certain amount (e.g., percentage, gallons, flow rate, etc). In such instances, an anomalous discrepancy 124 can be detected and/or identified. In some examples, the anomalous discrepancy may correlate to a percent loss for example, 5% loss or 5% difference between the water flowing into the zone or district and the water flowing out of the zone or district, while still accounting for water in storage containers and the like. In some examples, a machine learning model can be utilized to identify discrepancies between the water flowing in and the water flowing out. For example, a machine learning model trained on training data comprising flow rates and pressure sensor readings for a specific district or zone and or a generic district or zone can be utilized to predict an anomalous discrepancy based on differences between water flowing into the zone or district and the water flowing out of the zone or district.

Further, one or more hydraulic models 126 can be utilized to identify a possible leak location when an anomalous discrepancy has been identified. For example, a specific hydraulic model 128 can receive sensor data from the data model 122 and can utilize an amount of non-revenue water to determine a possible leak location. That is, a simulation with the identified rate of non-revenue water applied at various points throughout the system or zone's mains can be utilized to identify a possible leak location. Higher flow rates of water throughout a system correlate directly with lower observed pressures. Since the conditions that the hydraulic model uses to analyze the system are based on metered flows, the calibrated hydraulic model can identify the higher pressure at remotely monitored locations throughout the system or zone. The hydraulic analysis platform can compare observed pressures during the identified leak event with the simulated pressure in each of the independent simulations in which the non-revenue water rate is applied throughout the system. The simulated locations of the non-revenue water which align most closely with the observed remote system pressures will be categorized and communicated to utility staff as the most likely locations of the new leak. In some examples, the type of notification can be based on an attribute associated with the leak. For example, a large amount of non-revenue water due to a leak can warrant a faster type of notification (e.g., text notification, call notification, etc.).

As an example, a pressure and flow associated with a location 117A can be obtained from one or more sensors along the boundary of the district or zone 106. A hydraulic model can simulate an amount of non-revenue water at various water line junctions within district or zone 106. Accordingly, the hydraulic model can generate simulated flows and pressures for various water line junctions 117A-117F; as the non-revenue water leak can be simulated at different locations within the district or zone 106, the simulated pressure and flows generated via the hydraulic model that most closely align or otherwise are closest to the actual readings obtained from sensors 117A-117F can then be used to identify possible leak locations and/or possible water line segments that should be investigated closer for leak identification. In accordance with some examples, the hydraulic model 128 can perform the leak location operation as previously discussed.

In some examples, one or more pressure sensors are impulse-enabled pressure sensors capable of identifying pressure impulses. The one or more pressure sensors that are impulse-enabled pressure sensors can sample and record pressures at one or more connections at acquisition rates that are greater than other pressure sensors located throughout the district or zone 106. Alternatively, or in addition, one or more pressure sensors capable of acquiring pressure readings at acquisition rates capable of identifying pressure surges can provide such pressure reading to the data model 122 such that the data model can identify a pressure surge. Upon identifying a pressure surge by the impulse-enabled pressure sensor(s) and/or the data model 122, the data model 122 and/or a hydraulic model 126 can initiate a leak detection procedure in a manner that is the same as or similar to the manner previously discussed. Alternatively, or in addition, based on the identification of a pressure surge event by the data model and/or the impulse-enabled pressure sensor(s), one or more additional process for identifying infrastructure within the district or zone 106 affected (e.g., negatively affected) by the pressure surge event can be initiated. For example, the pressure surge event can potentially be mitigated to prevent the potentially damaging surge event from affecting other parts of the district or zone 106. As a non-limiting example, a pressure surge mitigation action can be accomplished by opening/closing one or more valves.

In some instances, the identified pressure surge event can be stored or otherwise logged for later impulse or surge event identification.

In some examples, the data model 122 and the hydraulic models 126 can simulate the operation of a water system and allow the user to plan for future scenarios 136, analyze past events 134, and determine the conditions 132 in parts of a system where measurement equipment is not available. For example, the data model 122 can store or log pressure, flow, and leak event data over time to statistically correlate past events with future potential events (anomaly detection). For example, by performing a past event analysis 134 using data from the data model 122, the identification of a possible or probable future event can be identified.

The data model 122 can use historical data to forecast near-term system demand using machine learning techniques, including autoregressive integrated moving average (ARIMA) methods, neural networks, and other forms of machine learning. For example, future what-if scenarios can be modeled using one or more hydraulic models 128, data from the data model 122, and/or forecasted system demand data.

In some examples, data stored by the data model 122 and a hydraulic model 128 can be used for future scenario planning 136 to identify deficiencies in a district or zone at each planning period of a master plan development based on design criteria. For example, streaming data and one or more hydraulic models 128 can be used to identify violations of master plan design criteria, including, but not limited to, pressure, fire flow, velocity, and head loss gradient. As one non-limiting example, a master plan design may require a specified flow and/or pressure to one or more components, such as a fire hydrant. Utilizing the historical data to forecast future system demand (for example, using a machine learning model), disruptions in flow and/or pressure due to future maintenance events, future seasonal events, or other future events can be modeled to determine if such event would violate the master plan design. If the flow and/or pressure at the component, such as the hydrant, does not meet the master plan design requirements, then a violation of such criteria can be logged. In examples, such modeling could be performed at different iterations or phases of a master plan design. For example, as the master plan evolves or an additional phase is added to the master plan, modeling simulations can identify violations of design criteria at various points in the design process. Further, the data stored by the data model 122 can be used to identify improvements to the district or zone and/or reprioritize projects based on one or more analysis and modeling techniques provided by the data model 122 and/or a hydraulic model 126. The hydraulic analysis platform can be used to gather regulatory data (maximum and average day demand, leak event duration and volume, and pressure data) on a continuous basis and automatically generate regulatory forms for review prior to submittal to a regulatory body. As another example, to evaluate conditions within an area of a zone or district 106 where measurement equipment is not available, pressure measurements and flow readings can be estimated using one or more hydraulic models 126 together with data from the data model 122.

The hydraulic analysis platform can be incorporated with Laboratory Information Management Systems (LIMS) to flag anomalous samples and automatically trigger hydraulic modeling source trace simulations in order to determine the potential extent of the contamination event.

The hydraulic analysis platform can be incorporated with Computerized Management Maintenance Systems (CMMS) to determine short and intermediate-term impacts to planned maintenance activities (e.g., the resilience of a system to a fire with the planned removal from service of a pump).

The hydraulic analysis platform can also allow a user to “check out” a version of the model at any given timestep to perform batch analyses and simulations, such as planning or outage simulations, in an offline manner. The model can be checked out with asset control schemes, demand, and boundary conditions loaded for a given point in time. The user can specify between a steady-state and extended period simulation (EPS) version to “check out” for an analysis.

In some examples, the hydraulic analysis platform can cause hydraulic grade lines to be rendered at a computing device in real-time and at any timestep between two points in the zone or district. The hydraulic grade line corrects for elevation so that losses due to friction, bends, and usage can be quickly and accurately be displayed from sources like pumps to any point in the system. The elevation model and hydraulic analyses from the hydraulic model facilitate this process within the hydraulic analysis platform.

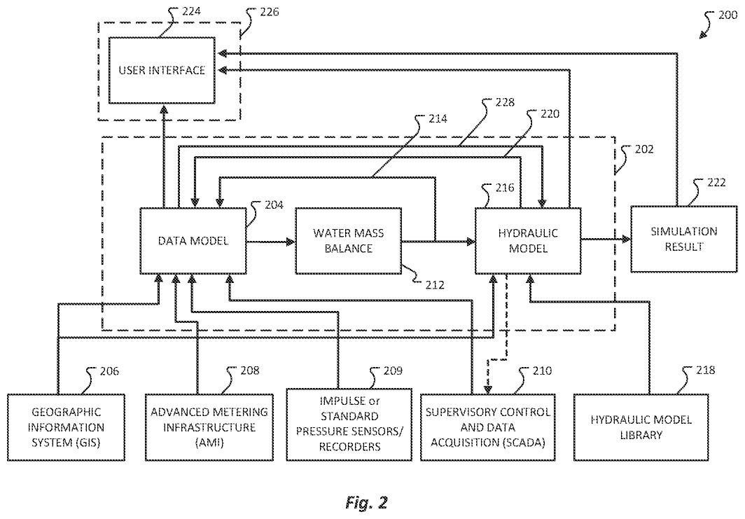

FIG. 2 depicts additional details of a hydraulic analysis platform 200 in accordance with examples of the present disclosure. As previously discussed, a hydraulic analysis platform 200 can include a data model 204 and a hydraulic model 216. Computations for the hydraulic analysis platform 200 can be performed utilizing computing system 202. In some examples, the data model 204 can receive sensor data and/or infrastructure data for a zone or district from a geographic information system 206, an advanced metering infrastructure 208, impulse or standard pressure sensors/recorders 209, and a supervisory control and data acquisition systems 210. The hydraulic analysis platform 200 can receive information from the geographic information system 206, where the information can include a network file layout that includes characteristic information for a water utility layout, district, or zone. As previously discussed, the hydraulic analysis platform 200 can receive sensor data specific to one or more sensors such as a flow sensor, pressure sensor, etc. for a zone or a district from the advanced metering infrastructure 208. In some examples, the data model 204 can ingest the information or the sensor data from an AMI source and/or directly access the information or the sensor data from an AMI source. Alternatively, or in addition, the data model 204 can ingest the information or the sensor data from an information provider that obtains sensor data from an AMI source. In some instances, the AMI source and/or the information provider can push sensor data or other information directly to the data model 204. As previously discussed, the data model 204 can additionally receive sensor data and in some instances control data from SCADA 210.

In examples, a water mass balance process 212 can be performed based on sensor data received from the AMI 208, SCADA 210, and other sensors located in a district or zone. That is, where the water flow into a zone our district is different than a water flow out of a zone or district as determined by the water mass balance process 212, a hydraulic model 216 can be selected to further analyze the district or zone for a possible leak. As previously discussed, the water mass balance process 212 can take into account water leaving the zone or district as a result of being stored in storage containers, vessels, or otherwise.

In some examples, a simulation result of the hydraulic model 216 can be output as a simulation result 222. The simulation result 222 can refer to the leak location, event, condition, and/or future demand as described with respect to FIG. 1. In accordance with some examples of the present disclosure, the simulation result 222 can be provided to a computing device 226 such that the simulation result can be rendered to or otherwise displayed at a user interface to 224 coupled to the computing device 226. In some examples, the computing device 226 can access data from the data model, simulation result 222, and/or hydraulic model 216 via a web interface provided by the computing device 202.

In accordance with some examples of the present disclosure, where a water mass balance operation 212 does not identify a discrepancy between the water flowing into and out of the district or zone, the hydraulic analysis platform 200 can return or otherwise, continue to log sensor data together with the result of the water mass balance operation 212. Where a leak location 220 is provided by the hydraulic model 216, the hydraulic model 216 can provide such information to the data model 204 for subsequent logging and further analysis. In some examples, the data model 204 can provide sensor data to the hydraulic model 216 to update or otherwise train the hydraulic model 216 when such hydraulic model 216 is dependent upon recent data. For example, a hydraulic model 216 can train a machine learning model employing one or more neural networks. A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can include a probability distribution resulting from the analysis of training data, such as a likelihood of an event occurring given a history of event contexts. Examples of models include neural networks, support vector machines, decision trees, Parzen windows, Bayesian, clustering, reinforcement learning, probability distributions, decision tree forests, and others. Models can be configured for various situations, data types, sources, and output formats. Thus, as data is acquired for a system, the hydraulic model 216 can be trained on system specific data thereby potentially increasing the accuracy of the hydraulic model 216.

As further depicted in FIG. 2, the hydraulic analysis platform 200 can provide a signal to the SCADA 210. In examples, the signal provided to the SCADA 210 can be configured to control a valve located in the zone of the water utility. For example, based on a location of an anomalous event as determined by the hydraulic model 216, a valve closest to the anomalous event can be closed based on the signal provided to the SCADA 210 from the hydraulic analysis platform 200. That is, the hydraulic analysis platform 200 can optionally push information back to the SCADA 210. In non-limiting examples, the hydraulic model 216 can provide the information that is sent to the SCADA 210, as depicted by the dashed line in FIG. 2.

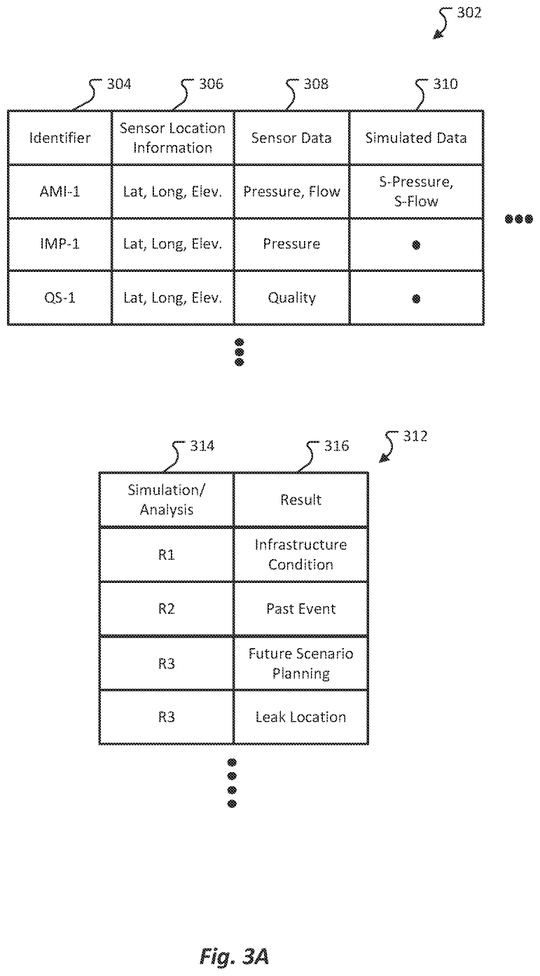

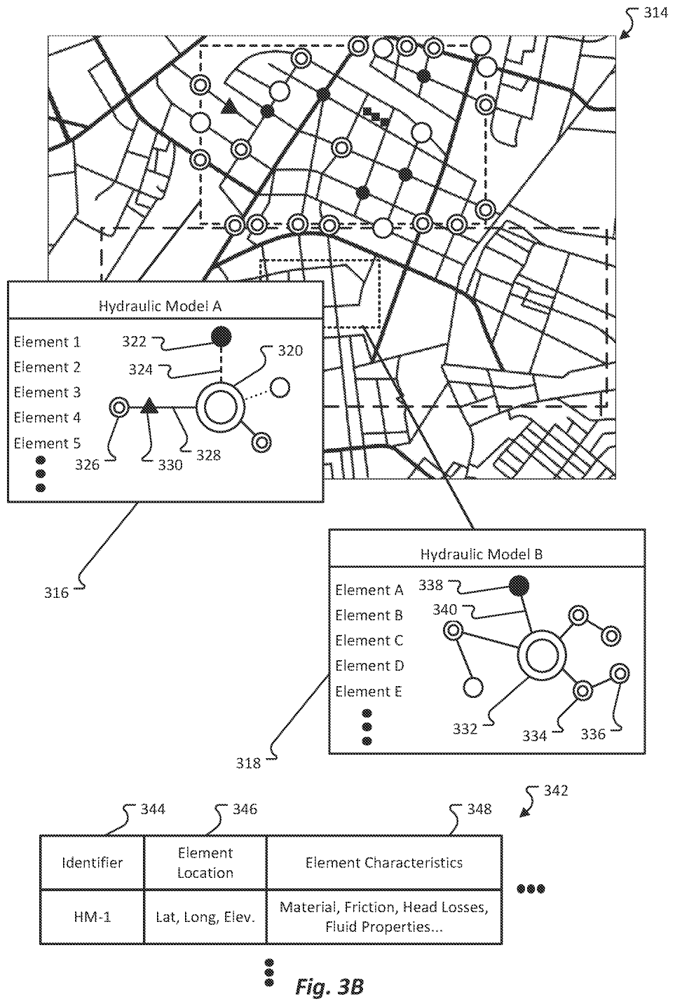

FIG. 3A depicts additional details of a data structure 302 created to store sensor data and/or GIS data or other data processed by the data model 204 of FIG. 2. In some examples, the data model 204 of FIG. 2 can identify one or more sensors utilizing an identifier 304. In some examples, the data model 204 of FIG. 2 can save or store such information, such as but not limited to, sensor location information 306, sensor data 308, simulated data 310, and any other sensor data. In some examples, the sensor data can refer to impulse or standard pressure data, water quality data, SCADA data, etc. In some implementations, another data structure 312 can be utilized to store or otherwise log simulation or analysis data generated by the data model and/or a hydraulic model. For example, a simulation or analysis can be identified using the identifier 314 and the result of simulation or analysis can be stored in accordance with the result field 316. Thus, for example, one or more simulations or analyses can be performed, and different results can be received and logged for future use. Of course, additional fields may be included in each of the data structures 302 and 312, although not depicted in FIG. 3A.

FIG. 3B depicts additional details of a hydraulic model, such as a hydraulic model 316 and 318. In examples, the hydraulic model 316 and 318 can be utilized to simulate different aspects of a district or zone. For example, a hydraulic model 316 can be used to identify or potentially identify one or more leaks in a district or zone. As depicted in FIG. 3B, the hydraulic model 316 can include a plurality of different elements and a mapping of each element with respect to another element, where each element can be coupled to or otherwise connected to another element. Thus, for example, sensor data from sensors 320, 322, 324, 326, and 328 can be utilized to identify a leak 330. As another example, the hydraulic model 318 can be utilized to predict water demand, identify master plan violations, trace a contaminate, and/or identify compliance with a future event (such as removal of a fire hydrant). Thus, similar to the hydraulic model 316, the hydraulic model 318 can include one or more sensors 332-338, where each of the one or more sensors 332-338 can be associated with one or more characteristics, such as material, friction, head losses, fluid properties, etc. In some examples, the hydraulic model, such as the hydraulic model 318, can include one or more characteristics, such as material, friction, head losses, fluid properties, etc., of other portions of the district or zone, such as a pipe or connection 340. Thus, the hydraulic model 318 can be used to determine or otherwise identify one or more characteristics of the district or zone. In accordance with examples of the present disclosure, each of the hydraulic models, such as 316 and/or 318, can be based on or otherwise created from GIS information.

As further depicted in FIG. 3B, a hydraulic model, such as hydraulic model 316 and/or hydraulic model 318, can be stored in a data structure 342. The data structure 342 can include an identifier 344 uniquely identifying the hydraulic model 316 and/or 318, location information 346, and/or characteristic information 348 for each of the hydraulic models. Although not explicitly indicated in FIG. 3B, the data structure 342 can include additional hydraulic models and hydraulic model information.

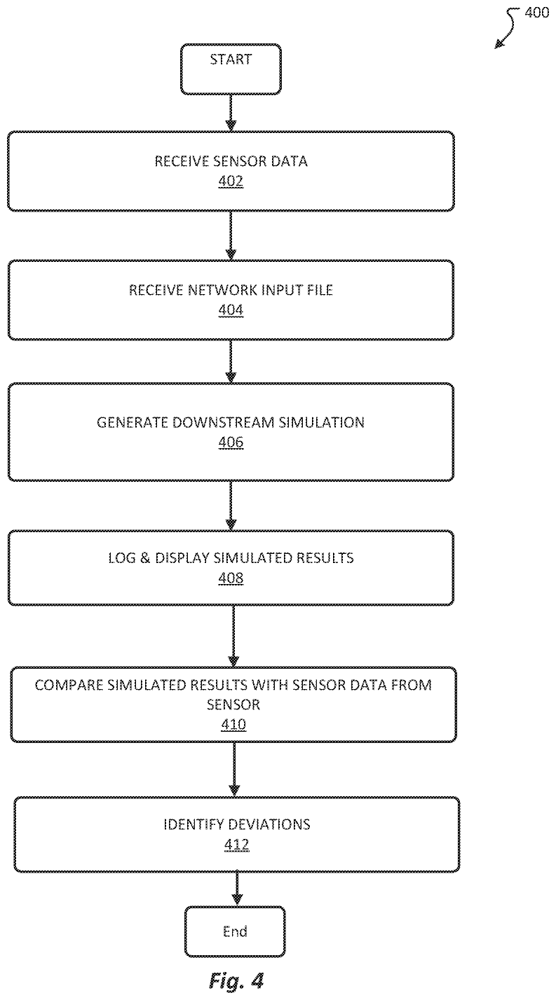

FIG. 4 depicts details of method 400 for identifying deviations existing between simulated results and actual sensor readings in accordance with examples of the present disclosure. A general order for the steps of method 400 is shown in FIG. 4. The method 400 may include more or fewer steps or may arrange the order of the steps differently than those shown in FIG. 4. Method 400 can be executed as a set of computer-executable instructions executed by a computer system and encoded or stored on a computer readable medium. In examples, aspects of the method 400 are performed by one or more processing devices, such as a computer or server. Further, method 400 can be performed by gates or circuits associated with a processor, Application Specific Integrated Circuit (ASIC), a field programmable gate array (FPGA), a system on chip (SOC), or other hardware device. Hereinafter, method 400 shall be explained with reference to the systems, components, modules, software, data structures, user interfaces, etc. described in conjunction with FIGS. 1-3B.

The method 400 starts and proceeds to 402, where sensor data can be received. In examples, the sensor data can be acquired by the data model, such as the data model 204 of FIG. 2 and/or the data model 122 of FIG. 1. As previously discussed, the sensor data can be pushed to the data model such that the sensor data is received at 402, or the data model can make a request for the data in accordance with a timed event or at the direction of a user. The method 400 can then proceed to 404, where a network input file can be received by the data model. That is, the network input file can refer to a file including various components of a zone or district, how each of the components are related, and/or other characteristics of the components. The rate at which the data model requests sensor data can be dependent upon the type of sensor data, access to the sensor data, and/or requirements of a hydraulic model. The method 400 can then proceed to 406, where the method 400 can generate downstream simulation data. In examples, the downstream simulation data can refer to data that is used to backfill or otherwise establish pressure and/or sensor readings for areas of a zone or district that may be unavailable. Alternatively, or in addition, the downstream simulation may refer to simulated sensor data for one or more sensors based on historical or information and boundary sensor data. For example, where a sensor is located within a district or zone, a simulated sensor reading for the sensor within the district or zone can be based on sensor data from a sensor located at the boundary. Thus, for instance, where a pressure or flow drop occurs over a specified period of time, simulated sensor data may deviate from actual sensor data received from the sensor. In some examples, a hydraulic model can be used to estimate or otherwise generate simulated sensor data downstream from a boundary sensor.

The method 400 can then proceed to 408, where the simulated data and/or results can be logged and/or provided to a computing device for rendering at a display device. In some examples, the logged results can be utilized to update, retrain, or finetune a machine learning model. In some examples, the method 400 can proceed to 410, where the simulated results or simulated sensor data can be compared with the actual sensor data received from the sensor. In some examples, the comparison can be performed by a machine learning model trained on training data specific to a district or zone. In some examples, the comparison can be performed by a machine learning model trained on training data from other districts or zones. The method 400 can then proceed to 412 where one or more deviations between the simulated sensor data and the actual sensor data can be identified. For example, based on the comparison at 410, a deviation greater than a specific threshold may cause an alarm condition such that one or more users are notified. As another example, a deviation greater than a specific threshold can trigger or otherwise cause another analysis or simulation to occur—for example, a leak detection hydraulic model to run. The method 400 may then end.

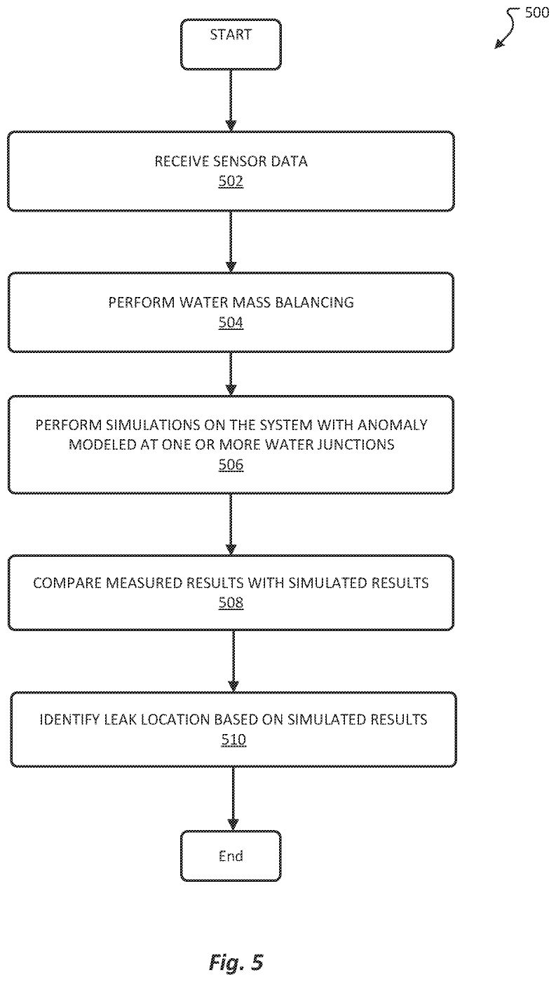

FIG. 5 depicts details of method 500 for identifying leak locations in a district or zone of a water utility in accordance with examples of the present disclosure. A general order for the steps of method 500 is shown in FIG. 5. The method 500 may include more or fewer steps or may arrange the order of the steps differently than those shown in FIG. 5. Method 500 can be executed as a set of computer-executable instructions executed by a computer system and encoded or stored on a computer readable medium. In examples, aspects of the method 500 are performed by one or more processing devices, such as a computer or server. Further, method 500 can be performed by gates or circuits associated with a processor, Application Specific Integrated Circuit (ASIC), a field programmable gate array (FPGA), a system on chip (SOC), or other hardware device. Hereinafter, method 500 shall be explained with reference to the systems, components, modules, software, data structures, user interfaces, etc. described in conjunction with FIGS. 1-4.

The method 500 starts and proceeds to 502, where sensor data can be received. In examples, the sensor data can be acquired by the data model, such as the data model 204 of FIG. 2 and/or the data model 122 of FIG. 1. As previously discussed, the sensor data can be pushed to the data model such that the sensor data is received at 502, or the data model can make a request for the data in accordance with a timed event or at the direction of a user. The method 500 can receive as input a network input file. That is, the network input file can refer to a file including various components of a zone or district, how each of the components are related, and/or other characteristics of the components. The rate at which the data model requests sensor data can be dependent upon the type of sensor data, access to the sensor data, and/or requirements of a hydraulic model. Method 500 can then proceed to 504, where a water mass balancing process can be performed. As previously discussed, the hydraulic analysis platform, via the data model, can complete a water mass balance at periodic timesteps to determine whether the volume of water leaving the zone or system through metered connections is equal to the volume of water entering the zone or system at the boundaries or being stored. When the data model identifies an anomalous discrepancy, for example at 506, the rate of non-revenue water (NRW—water leaving the zone or district without being metered, typically due to leaks or flushing) is totaled and the method 500 can perform a simulation with the identified rate of NRW applied at various points throughout the zone or system, for example at water mains, branches, storage vessels, or otherwise. In examples, higher flow rates of water throughout a zone or district correlate with lower observed pressures. Thus, since the conditions that the hydraulic model uses to analyze the zone or district are based on metered flows, the calibrated hydraulic model can determine or calculate a higher pressure at remotely monitored pressure points throughout the zone or system.

Method 500 can proceed to 508, where the method can then compare observed pressures during the identified leak event with the simulated pressure in each of the independent simulations in which the NRW rate is applied throughout the zone or system. The simulated locations of the NRW which align most closely with the observed remote system pressures can be categorized, identified, and/or recorded and communicated to utility staff as the most likely locations of a new leak at 510. The method 500 can then end and/or repeat in accordance with a timed or scheduled event or at the direction of a user. In some examples, pressure sensors and metered data from an AMI can be used to detect a leak in a district or zone. For example, rather than (or in addition to) performing a water mass balance at periodic timesteps to determine whether the volume of water leaving the zone or system through metered connections, pressure sensors and flow rates within the district or zone can be utilized to identify a potential water leak location. For example, discrepancies between water flowing into and out of an area within a district or zone can be obtained utilizing data from AMI. Thus, for example at 506, the discrepancy between water flowing into and out of an area within a district or zone is totaled and the method 500 can perform a simulation using the discrepancy applied at various points throughout the area within a district or zone. In examples, higher flow rates of water throughout an area within a zone or district correlate with lower observed pressures. Thus, since the conditions that the hydraulic model uses to analyze the area within the zone or district are based on AMI metered flows, the calibrated hydraulic model can determine or calculate a higher pressure at remotely monitored pressure points in the area within the district or zone.

Thus, at 508, the method can then compare observed pressures during the identified leak event with the simulated pressure in each of the independent simulations in which the discrepancy is applied within the area of the district or zone. The simulated locations of the discrepancy which align most closely with the observed remote system pressures can be categorized, identified, and/or recorded and communicated to utility staff as the most likely locations of a new leak at 510. The method 500 can then end and/or repeat in accordance with a timed or scheduled event or at the direction of a user.

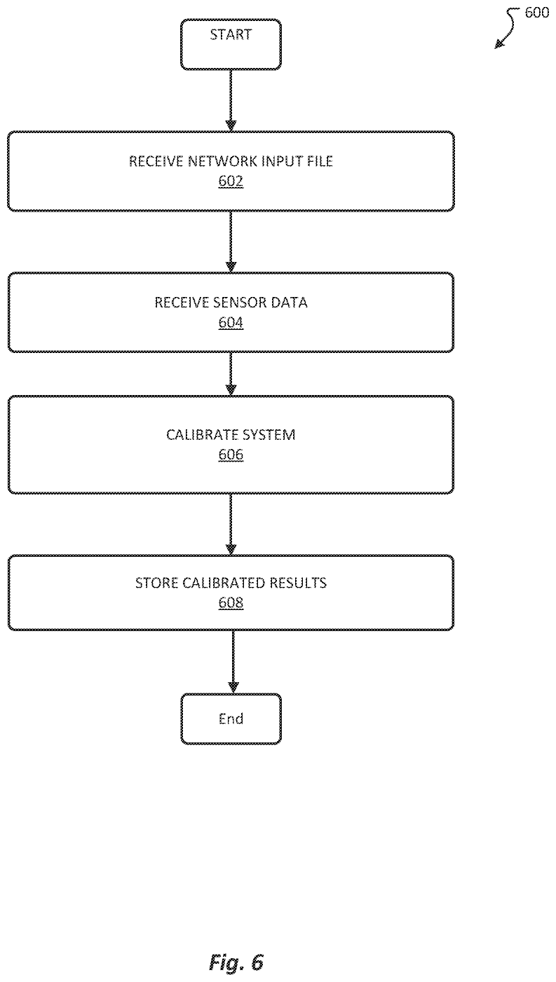

FIG. 6 depicts details of method 600 for calibrating a hydraulic analysis platform specific to a zone or district of a water utility in accordance with examples of the present disclosure. A general order for the steps of method 600 is shown in FIG. 6. The method 600 may include more or fewer steps or may arrange the order of the steps differently than those shown in FIG. 6. Method 600 can be executed as a set of computer-executable instructions executed by a computer system and encoded or stored on a computer readable medium. In examples, aspects of the method 600 are performed by one or more processing devices, such as a computer or server. Further, method 600 can be performed by gates or circuits associated with a processor, Application Specific Integrated Circuit (ASIC), a field programmable gate array (FPGA), a system on chip (SOC), or other hardware device. Hereinafter, method 600 shall be explained with reference to the systems, components, modules, software, data structures, user interfaces, etc. described in conjunction with FIGS. 1-5.

The method 600 starts and proceeds to 602, where a network file indicative of one or more components of a district or zone of a water utility is received. That is, the network input file can refer to a file including various components of a zone or district, how each of the components are related, and/or other characteristics of the components. The method 600 can then proceed to 604, where sensor data can be received. In examples, the sensor data can be acquired by the data model, such as the data model 204 of FIG. 2 and/or the data model 122 of FIG. 1. As previously discussed, the sensor data can be pushed to the data model such that the sensor data is received at 604, or the data model can make a request for the data in accordance with a timed event or at the direction of a user. The rate at which the data model requests sensor data can be dependent upon the type of sensor data, access to the sensor data, and/or requirements of a hydraulic model.

At 606, the hydraulic analysis platform can then be calibrated based on sensor data and the received network input file. For example, based on the received network input file, a data model can generate an expected pressure loss due to material, elevation change, and water line length. Existing leaks in the district or zone can be accounted for using optimization and uncertainty analyses (such as Monte Carlo simulations) to determine several potential leak locations. In some examples, the determined leak locations can be investigated to determine if an actual leak does in fact exist. If the leak does not exist, one or more calibration parameters can be generated based on the difference between the simulated sensor data and the actual sensor data. The method 600 can proceed to 608 where the calibrated results can be stored. In some examples, the calibrated results can be stored in a data structure that is accessed periodically to retrieve the calibration parameters and/or to update the calibration parameters. In some examples, the calibrated results can be stored by adjusting the network input file physical characteristics based on the calibrated results. For example, a physical component described in the network input file can be adjusted to add or update a leakage rate parameter associated with a physical component.

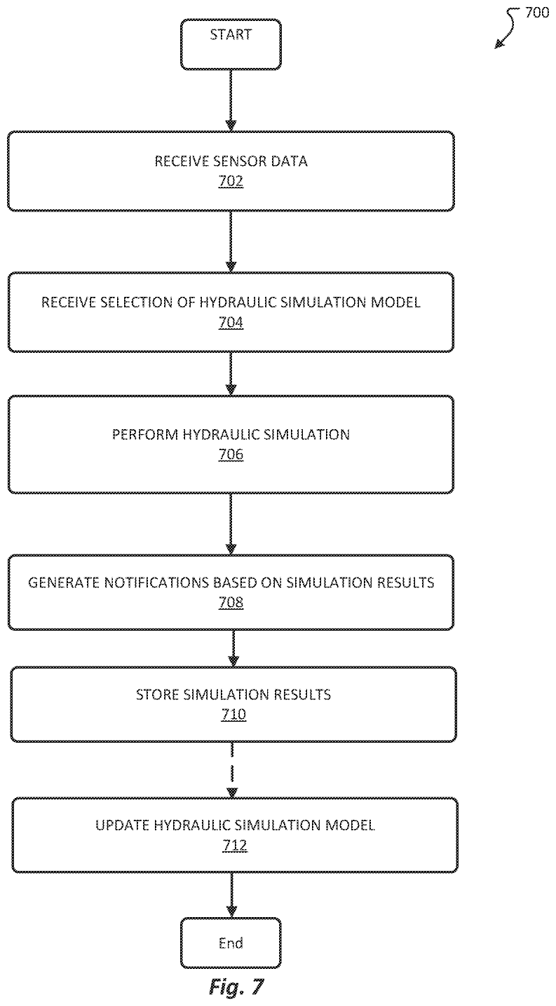

FIG. 7 depicts details of method 700 for selecting a hydraulic model and performing a hydraulic simulation using the selected hydraulic model in accordance with examples of the present disclosure. A general order for the steps of method 700 is shown in FIG. 7. The method 700 may include more or fewer steps or may arrange the order of the steps differently than those shown in FIG. 7. Method 700 can be executed as a set of computer-executable instructions executed by a computer system and encoded or stored on a computer readable medium. In examples, aspects of the method 700 are performed by one or more processing devices, such as a computer or server. Further, method 700 can be performed by gates or circuits associated with a processor, Application Specific Integrated Circuit (ASIC), a field programmable gate array (FPGA), a system on chip (SOC), or other hardware device. Hereinafter, method 700 shall be explained with reference to the systems, components, modules, software, data structures, user interfaces, etc. described in conjunction with FIGS. 1-6.

The method 700 starts and proceeds to 702, where sensor data can be received. In examples, the sensor data can be acquired by the data model, such as the data model 204 of FIG. 2 and/or the data model 122 of FIG. 1. As previously discussed, the sensor data can be pushed to the data model such that the sensor data is received at 702, or the data model can make a request for the data in accordance with a timed event or at the direction of a user. The method 700 can receive as input a network input file. That is, the network input file can refer to a file including various components of a zone or district, how each of the components are related, and/or other characteristics of the components. The rate at which the data model requests sensor data can be dependent upon the type of sensor data, access to the sensor data, and/or requirements of a hydraulic model. Method 700 can then proceed to 704, where a selection of a hydraulic simulation model is received. In some examples, the selection of the hydraulic simulation model is received from a user intentionally desiring to execute a specified simulation. In some examples, the selection of the hydraulic simulation model can be based on one or more anomalous events determined by the data model. For example, an anomalous event indicating that a discrepancy exists between water flowing into the district or zone and water flowing out of the district or zone may cause a leak detection hydraulic model to be selected.

At 706, the selected hydraulic simulation can be performed by the hydraulic analysis platform or exported as a hydraulic model file to be used with other hydraulic modeling software packages and applications. For example, the hydraulic simulation can be exported as a pre-loaded, ready-to-run hydraulic model file to be used with any common hydraulic modeling software package that can run an EPANET file. Based on the results of the hydraulic simulation, one or more notifications can be generated and sent to one or more users, and/or the results of the simulation can be stored in a data structure at 710. In some examples, the method 700 can update, retrain, or fine tune one or more hydraulic simulation models at 712 based on the results of the hydraulic simulation performed at 706. For example, where simulated data matches sensor readings, a machine learning model specific to a district or zone can be retrained using training data including the simulation result.

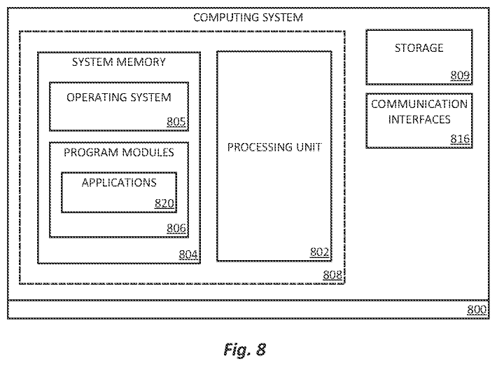

FIG. 8 is a block diagram illustrating physical components (e.g., hardware) of a computing system 800, such as a hydraulic analysis platform, with which aspects of the disclosure may be practiced. The computing system 800 components described below may be suitable for the computing and/or processing devices described above. In a basic configuration, the computing system 800 may include at least one processing unit 802 and a system memory 804. Depending on the configuration and type of computing device, the system memory 804 may comprise, but is not limited to, volatile storage (e.g., random-access memory (RAM)), non-volatile storage (e.g., read-only memory (ROM)), flash memory, or any combination of such memories.

The system memory 804 may include an operating system 805 and one or more program modules 806 suitable for running software application 820, such as one or more components supported by the systems described herein. As examples, system memory 804 may include a data model 122/204, hydraulic model 126/216 and/or a water mass balance process 212. The computing system 800 may have additional features or functionality. For example, the computing system 800 may also include additional data storage devices (removable and/or non-removable) such as, for example, magnetic disks, optical disks, or tape. Such additional storage is illustrated in FIG. 8 by a removable and non-removable storage 809.

As stated above, a number of program modules and data files may be stored in system memory 804. While executing on the processing unit 802, the program modules 806 (e.g., data model 122/204, hydraulic model 126/216 and/or a water mass balance process 212) may perform processes including, but not limited to, the aspects, as described herein.

Furthermore, embodiments of the disclosure may be practiced in an electrical circuit, discrete electronic element, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality, all of which are integrated (or “burned”) onto the chip substrate as a single integrated circuit. When operating via an SOC, the functionality, described herein, with respect to the capability of client to switch protocols may be operated via application-specific logic integrated with other components of the computing system 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

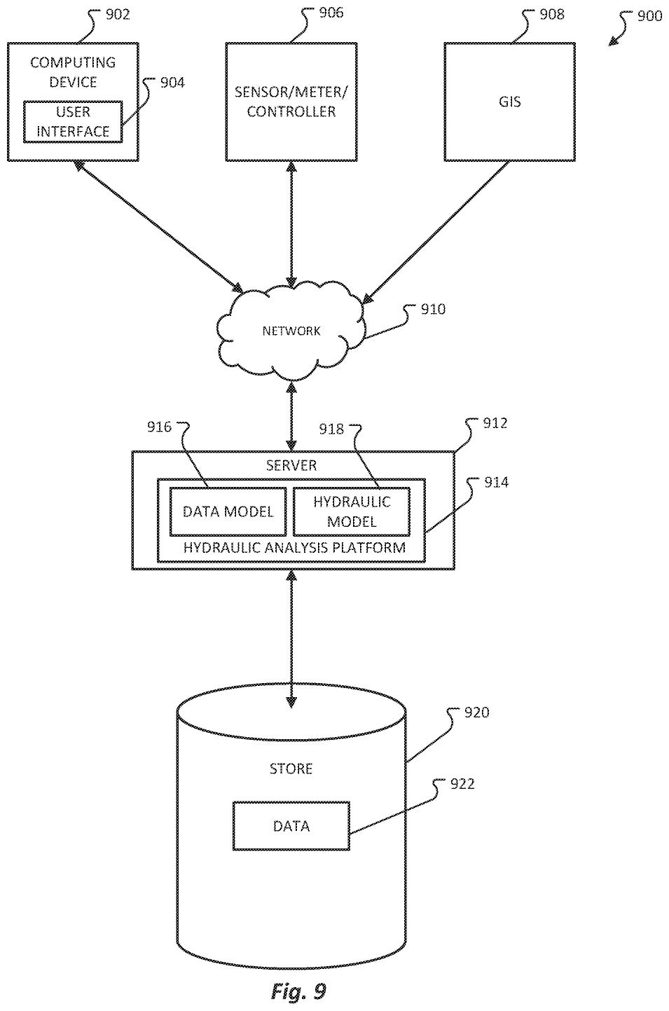

The computing system 800 may also have one or more input device(s) such as a keyboard, a mouse, a pen, a sound or voice input device, a touch or swipe input device, etc. Output device(s) such as a display, speakers, a printer, etc. may also be included. The aforementioned devices are examples and others may be used. The computing system 800 may include one or more communication interface 816, allowing communications with other computing devices and information systems. Examples of a communication interface 816 include, but are not limited to, radio frequency (RF) transmitter, receiver, and/or transceiver circuitry; universal serial bus (USB), parallel, and/or serial ports. FIG. 9 illustrates details of a system 900 for processing data received at a computing system from a remote source, such as a computing device 902, sensor, meter, and/or controller 906, and/or GIS 908 as previously described. In examples, a hydraulic analysis platform 914, including one or more of a data model 916 and/or hydraulic model 918, can be employed by a server device 912. The server device 912 can be the same as or similar to the computing system 800 of FIG. 8 and/or the computing system 202 of FIG. 2. The hydraulic analysis platform 914 can be the same as or similar to the hydraulic analysis platform 200 of FIG. 2; the data model can be the same as or similar to the data model 122 of FIG. 1 and/or data model 204 of FIG. 2; and the hydraulic model can be the same as or similar to the hydraulic model 126/128 of FIG. 1 and/or hydraulic model 216 of FIG. 2. The server device 912 can provide data to and from the computing device 902 through a network 910, where the computing 902 can be one or more of a personal computer, a tablet computing device, and/or a mobile computing device (e.g., a smart phone). In examples, sensor/meter/controller 906 can refer to AMI (e.g., AMI 208 of FIG. 2), SCADA (e.g., SCADA 210 of FIG. 2), impulse or standard pressure sensors/recorders (e.g., impulse or standard pressure sensors/recorders 209 of FIG. 2) or other data providers. Thus, sensor/meter/controller 906 can provide data to the server device 912 for additional processing. In examples, the server device 912 can communicate information to the computing device 902, where the computing device 902 can cause one or more graphical depictions of the data to be rendered to a user interface 904. In some examples, the server device 912 can communicate information to the sensor/meter/controller 906 to control one or more aspects of a water utility infrastructure. In examples, the store 920 can store data 922, where the data 922 can refer to sensor data, meter data, impulse data, GIS data, water utility infrastructure data, etc. used by and/or generated by the hydraulic analysis platform 914.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices.

The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112 (f). Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

What is claimed is:

1. A hydraulic analysis platform for managing a hydraulic distribution network of a water utility, the hydraulic analysis platform comprising:
a data model configured to receive data from a plurality of hydraulic sensors, wherein the plurality of hydraulic sensors is located at a boundary zone of the water utility and include at least one pressure sensor and at least one flow meter;
a water mass balancer configured to determine a presence of an anomalous event based on a metered amount of water flowing into the zone of the water utility and a metered amount of water flowing out of the zone of the water utility; and
a hydraulic model configured to perform a plurality of simulations at multiple locations of the zone of the water utility when the water mass balancer determines an anomalous event is present, wherein for each location of the multiple locations, the hydraulic model generates simulated data for one or more hydraulic sensors within the zone of the water utility based on the data received from the plurality of hydraulic sensors located at the boundary zone of the water utility and a difference between the metered amount of water flowing into the zone of the water utility and the metered amount of water flowing out of the zone of the water utility, wherein a location of the anomalous event is identified based on simulated data for the one or more hydraulic sensors being closest to the data received from the plurality of hydraulic sensors located at the boundary zone of the water utility,
wherein the hydraulic analysis platform is configured to generate an anomalous event notification based on the location of the anomalous event and the difference between the metered amount of water flowing into the zone of the water utility and the metered amount of water flowing out of the zone of the water utility.

2. The hydraulic analysis platform of claim 1, wherein the data model is configured to receive data from the plurality of hydraulic sensors via an advanced metering infrastructure system.

3. The hydraulic analysis platform of claim 1, wherein the hydraulic analysis platform is configured to cause the data received from the plurality of hydraulic sensors and the location of the anomalous event to be rendered to a display device.

4. The hydraulic analysis platform of claim 1, wherein the data model is configured to receive a network input model describing a plurality of different characteristics of multiple elements comprising the zone of the water utility, wherein the data model is further configured to generate one or more pressure and/or flow indications for one or more elements comprising the zone of the water utility.

5. The hydraulic analysis platform of claim 1, wherein the data model is configured to generate training data to train a machine learning model that predicts water flow rates and water pressures for a plurality of elements comprising the zone of the water utility.

6. The hydraulic analysis platform of claim 1, wherein the hydraulic analysis platform is configured to generate one or more signals to control one or more valves of the zone of the water utility based on the location of the anomalous event.

7. The hydraulic analysis platform of claim 1, wherein the anomalous event is a water leak.

8. The hydraulic analysis platform of claim 1, wherein the water mass balancer determines the anomalous event is present when the difference between the metered amount of water flowing into the zone of the water utility and the metered amount of water flowing out of the zone of the water utility is greater than a threshold.

9. The hydraulic analysis platform of claim 1, wherein the difference between the metered amount of water flowing into the zone of the water utility and the metered amount of water flowing out of the zone of the water utility excludes an amount of water flowing into one or more storage vessels.

10. A method for managing a hydraulic distribution network of a water utility, the method comprising:
receiving data from a plurality of hydraulic sensors located at a boundary zone of the water utility, the plurality of hydraulic sensors including at least one pressure sensor and at least one flow meter;
determining a presence of an anomalous event based on a metered amount of water flowing into the zone of the water utility and a metered amount of water flowing out of the zone of the water utility; and
performing a plurality of simulations at multiple locations of the zone of the water utility when the anomalous event is present by generating simulated data for one or more hydraulic sensors within the zone of the water utility based on the data received from the plurality of hydraulic sensors located at the boundary zone of the water utility and a difference between the metered amount of water flowing into the zone of the water utility and the metered amount of water flowing out of the zone of the water utility; and
identifying a location of the anomalous event based on the simulated data for the one or more hydraulic sensors being closest to the data received from the plurality of hydraulic sensors located at the boundary zone of the water utility.

11. The method of claim 10, further comprising receiving data from the plurality of hydraulic sensors via an advanced metering infrastructure system.

12. The method of claim 10, further comprising causing the data received from the plurality of hydraulic sensors and the location of the anomalous event to be rendered to a display device.

13. The method of claim 10, further comprising:
receiving a network input model describing a plurality of different characteristics of multiple elements comprising the zone of the water utility; and
generating one or more pressure and/or flow indications for one or more elements comprising the zone of the water utility.

14. The method of claim 10, further comprising generating training data to train a machine learning model that predicts water flow rates and water pressures for a plurality of elements comprising the zone of the water utility.

15. The method of claim 10, further comprising generating one or more signals to control one or more valves of the zone of the water utility based on the identification of the anomalous event.

16. The method of claim 10, wherein the anomalous event is a water leak.

17. The method of claim 10, wherein the anomalous event is an impulse event.

18. The method of claim 10, wherein the difference between the metered amount of water flowing into the zone of the water utility and the metered amount of water flowing out of the zone of the water utility excludes an amount of water flowing into one or more storage vessels.

19. A hydraulic analysis platform for managing a hydraulic distribution network of a water utility, the hydraulic analysis platform comprising:
a data model configured to receive data from a plurality of hydraulic sensors, wherein the plurality of hydraulic sensors is located at a boundary zone of the water utility and include at least one pressure sensor and at least one flow meter;
a water mass balancer configured to determine a presence of an anomalous event based on a metered amount of water flowing into the zone of the water utility and a metered amount of water flowing out of the zone of the water utility while excluding an amount of water flowing into one or more storage vessels; and
a hydraulic model configured to perform a plurality of simulations at multiple locations of the zone of the water utility when the water mass balancer determines an anomalous event is present, wherein for each location of the multiple locations, the hydraulic model generates simulated data for one or more hydraulic sensors within the zone of the water utility based on the data received from the plurality of hydraulic sensors located at the boundary zone of the water utility and a difference between the metered amount of water flowing into the zone of the water utility and the metered amount of water flowing out of the zone of the water utility while excluding the amount of water flowing into one or more storage vessels, wherein a location of the anomalous event is identified based on simulated data for the one or more hydraulic sensors being closest to the data received from the plurality of hydraulic sensors located at the boundary zone of the water utility,
wherein the hydraulic analysis platform is configured to generate one or more signals to control one or more valves of the zone of the water utility based on the location of the anomalous event.

20. The hydraulic analysis platform of claim 19, wherein the anomalous event is a water leak.
